(19) United States
(12) Patent Application Publication
(10) Pub. No.: US 2012/0054651 A1
(43) Pub. Date: Mar. 1, 2012

(54) CLOCK DISPLAYING SYSTEM AND METHOD FOR DISPLAYING SWITCHABLE CLOCK

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/165,411

(22) Filed: Jun. 21, 2011

(30) Foreign Application Priority Data
Aug. 27, 2010 (CN) 201010265253.3

(51) Int. Cl. G06F 3/048

(52) U.S. Cl. 715/764

(57) ABSTRACT

A clock displaying system includes a display, a placing module, a clock user interface (UI) module, a trigger and a processor. The placing module designates a clock area on the display. The clock UI module creates at least one clock UI at the clock area. The at least one clock UI displays a first clock from a plurality of clocks in different time zones. Each of the plurality of clocks associates with an allopatric time. The trigger monitors a trigger event. The processor updates the plurality of clocks in response to the trigger event.

### BACKGROUND

1. Technical Field

The disclosure generally relates to a clock displaying system and method for displaying a switchable clock.

2. Description of Related Art

Multi-Clock is designed to show the times of different time zones on an electronic device, such a smart phone. After users add favorite time zones, the electronic device will display the correct time according to time zone values. Each clock comes from many image components, and takes much CPU time to calculate the image components to display a clock. If users add many time-zone clocks, such as, over 10 clocks, it will be difficult to update all image components at the same time. This will cause electronic device to leg.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a system for providing multi-clocks on a user interface of an embedded electronic device in one embodiment.

FIG. 2 is an illustrate view of a user interface in one embodiment.

FIG. 3 is a flow chart of a method for displaying a clock according to one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming languages such as Java, C, or Assembly. One or more software instructions in the modules may be embedded in firmware, such as an EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

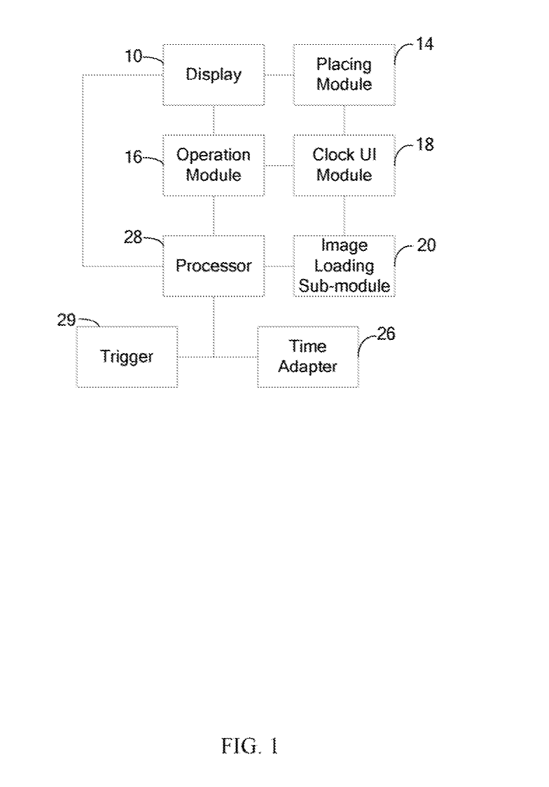

Referring to FIG. 1, in one embodiment, a system for providing multi-clocks on a user interface (UI) of an embedded electronic device includes a display 10, a placing module 14, an operation module 16, a clock UI module 18, a processor 28, a trigger 29, and a time adapter 26.

The display 10 is used to display the UI. The display 10 may be a touch screen.

The placing module 14 may designate a clock area on the display 10 at a predetermined position and size. The clock area can be changed by user. The placing module 14 may store a favorite setting of the user for the clock area into an Extensible Markup Language (XML) file for later use.

The operation module 16 may detect a slide operation on the clock area and generate an operating signal to the processor 28 when detecting a slide operation on the clock area.

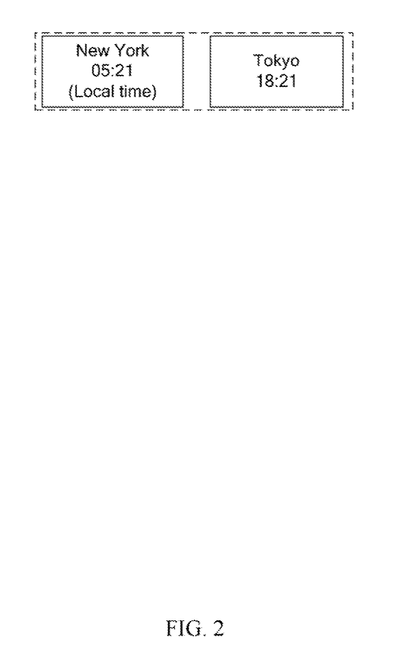

Referring to FIG. 2, the clock UI module 18 may create one or more clocks UI on the clock area. A plurality of clocks may be constructed by user. The plurality of clocks may be associated with a plurality of allopatric times and may belong to different time zones. Each clock UI may display one clock from the plurality of clocks defined by the user. The non-displayed clocks in the plurality of clocks may work in the background. The clock UI module 18 may create the one or more clocks UI by invoking an image loading sub-module 20 to draw images to present the clock. The displayed clock may be a digit clock, or a hand clock. A first clock may be switched to a second clock on the clock UI when the operation module 16 detects a slide operation on the clock area.

The image loading sub-module 20 may decode images and store the decoded images into the cache before creating the at least one clock UI at the clock area. The image loading sub-module 20 may decode images in forms of BMP, JPEG, PNG, GIF, or TIFF. The image loading sub-module 20 may create a queue to sequent load decoded images according to the display clock.

The time adapter 26 may obtain a local time. The local time may be provided by operating system or from the Internet. The local time is in a local time zone.

The trigger 29 may monitor for a trigger event. The processor 28 may update the plurality of clocks in response to the trigger event. The trigger event may be generated at a pre-determined frequency, such as one minute, or ten seconds. The trigger event may also be an operation of the user. The processor 28 may update the plurality of clocks according to the local time and time differences of allopatric time zones relative to locate time zone.

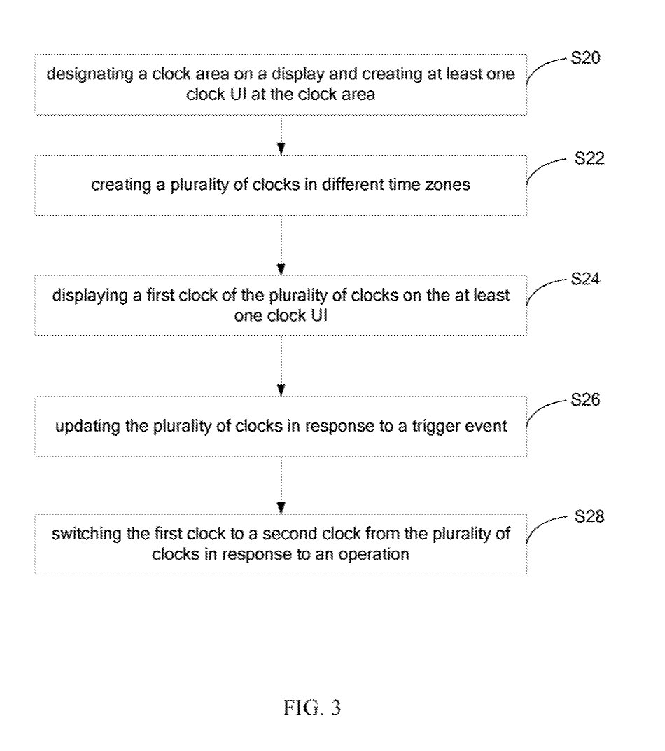

Referring to FIG. 3, a computer-implemented method for a clock on the electronic device includes the following blocks.

Block S20, designating a clock area on a display and creating at least one clock UI at the clock area.

Block S22, creating a plurality of clocks in different time zones. Each of the display clocks is associated with an allopatric time.

Block S24, displaying a first clock of the plurality of clocks on the at least one clock UI. Block S24 may further include decoding images and storing the decoded images into a cache before creating the at least one clock UI at the clock area.

Block S26, updating the plurality of clocks may be updated in response to a trigger event when the plurality of clocks need to be refreshed. In one embodiment, updating the plurality of clocks in response to the trigger event may further include updating the plurality of clocks according to the local time at a pre-determined frequency. In other embodiments, updating the plurality of clocks in response to a trigger event may further include updating the plurality of clocks according to the local time occurs every minute.

Block S28, switching the first clock to a second clock from the plurality of clocks in response to an operation. In one embodiment, the operation is a slide operation.

While the present disclosure has been illustrated by the description of the embodiments thereof, and while the embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain blocks of methods described may be removed, others may be added, and the sequence of blocks may be altered. It is also to be understood that the description and the claims drawn to a method may include some indication in reference to certain blocks. However, the indication used is only to be viewed for identification purposes and not as a suggestion as to an order for the blocks.

What is claimed is:

1. A clock displaying system in an embedded electronic device, comprising:
a display;
a placing module adapted to designate a clock area on the display;
a clock user interface(UI) module adapted to create at least one clock UI at the clock area, the at least one clock UI adapted to display a first clock from a plurality of clocks in different time zones, wherein each of the plurality of clocks is associated with an allopatric time;
a trigger, adapted to monitor a trigger event; and
a processor, adapted to update the plurality of clocks in response to the trigger event.

2. The clock display system of the claim 1, wherein the trigger event is generated at a pre-determined frequency.

3. The clock display system of the claim 2, wherein the trigger event occurs every minute of a local time.

4. The clock display system of the claim 1, wherein the clock UI module further comprises an image loading sub-module and a cache, and the image loading sub-module is adapted to decode images and store the decoded images into the cache before creating the at least one clock UI at the clock area.

5. The clock display system of the claim 1, further comprising an operation module, wherein the display is a touch display, and the clock UI module is adapted to switch the first clock when the operation module detects a slide operation on the clock area.

6. The clock display system of the claim 1, wherein the processor is adapted to update the plurality of clocks according to the local time and time differences of allopatric time zones relative to a local time zone.

7. A computer-implemented method for displaying a clock on an electronic device, comprising:
creating a plurality of clocks in different time zones; wherein each of clocks is associated with an allopatric time;
displaying a first clock of the plurality of clocks on at least one clock user interface (UI); and
switching the first clock to a second clock from the plurality of clocks in response to an operation.

8. The method of the claim 7 further comprising:
designating a clock area on a display; and
creating the at least one clock UI at the clock area for displaying the first clock.

9. The method of the claim 8, further comprising decoding images and storing decoded images into a cache before creating the at least one clock UI at the clock area.

10. The method of the claim 7, further comprising updating the plurality of clocks in response to a trigger event.

11. The method of the claim 10, wherein updating the plurality of clocks in response to the trigger event further comprises updating the plurality of clocks according to a local time at a pre-determined frequency.

12. The method of the claim 10, wherein updating the plurality of clocks in response to the trigger event further comprises updating the plurality of clocks according to the local time occurs every minute.

13. The method of the claim 7, wherein the switching the first clock to the second clock from the plurality of clocks in response to the operation further comprises switching the first clock to the second clock, from the plurality of clocks, in response to a slide operation on the clock area.

14. A computer-implemented method, comprising:
providing a display; a placing module, adapted to designate a clock area on the display; a clock user interface(UI) module, adapted to create at least one clock UI at the clock area, the at least one clock UI is adapted to display a first clock from a plurality of clocks in different time zones; a trigger, adapted to monitor a trigger event; and a processor, adapted to update the plurality of clocks in response to the trigger event; wherein each of the plurality of clocks is associated with an allopatric time;
creating the plurality of clocks in different time zones;
displaying the first clock of the plurality of clocks on the at least one clock UI;
switching the first clock to a second clock from the plurality of clocks in response to an operation.
